(19) United States
(12) Patent Application Publication
(10) Pub. No.: US 2024/0355209 A1
(43) Pub. Date: Oct. 24, 2024

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi (JP)

(72) Inventor: Hiroyuki MORI, Tokyo-to (JP)

(73) Assignee: TOYOTA JIDOSHA KABUSHIKI KAISHA, Toyota-shi (JP)

(21) Appl. No.: 18/602,245

(22) Filed: Mar. 12, 2024

(30) Foreign Application Priority Data
Apr. 24, 2023 (JP) 2023-071112

(51) Int. Cl. G08G 1/16; B60W 30/18; B60W 60/00

(52) U.S. Cl. CPC G08G 1/167; B60W 30/18163; B60W 60/0016

(57) ABSTRACT

A vehicle controller includes a processor configured to determine whether a reproposal condition for reproposing lane change control for a host vehicle to change lanes is satisfied, when a proposal of the lane change control is not accepted or when execution of the lane change control is interrupted after acceptance of the lane change control, and repropose execution of the lane change control to a driver of the host vehicle via a notification device provided for the host vehicle, when the reproposal condition is satisfied. The processor determines that the reproposal condition is satisfied, when a start condition for starting the lane change control is predicted to be satisfied.

### FIELD

The present invention relates to a vehicle controller, a method, and a computer program for vehicle control.

### BACKGROUND

A technique to automatically execute lane change control has been proposed (see Japanese Unexamined Patent Publication No. 2020-52658).

### SUMMARY

Depending on the circumstances of a vehicle, a proposal of a lane change may not be accepted, or lane change control may be interrupted during execution thereof. Since the circumstances of a vehicle change every moment, it is desirable that a proposal for executing lane change control again can be made at appropriate timing.

It is an object of the present invention to provide a vehicle controller that can repropose unfinished lane change control at appropriate timing.

According to an embodiment, a vehicle controller is provided. The vehicle controller includes a processor configured to: determine whether a reproposal condition for reproposing lane change control for a host vehicle to change lanes is satisfied, when a proposal of the lane change control is not accepted or when execution of the lane change control is interrupted after acceptance of the lane change control, and repropose execution of the lane change control to a driver of the host vehicle via a notification device provided for the host vehicle, when the reproposal condition is satisfied. The processor determines that the reproposal condition is satisfied, when a start condition for starting the lane change control is predicted to be satisfied.

The processor preferably determines that the reproposal condition is satisfied, when the start condition is predicted to be satisfied after a predetermined action performed by the driver.

The processor preferably modifies the number of times or a period of notification of the reproposal, depending on a reason for proposing the lane change control of which execution is interrupted.

The processor is preferably further configured to start executing the lane change control when the driver performs operation of approval for the reproposal via an operating device provided for the host vehicle. The operation of approval for the reproposal is preferably simpler than operation for the driver to give an instruction of the lane change control.

According to another embodiment, a method for vehicle control is provided. The method includes determining whether a reproposal condition for reproposing lane change control for a host vehicle to change lanes is satisfied, when a proposal of the lane change control is not accepted or when execution of the lane change control is interrupted after acceptance of the lane change control; and reproposing execution of the lane change control to a driver of the host vehicle via a notification device provided for the host vehicle, when the reproposal condition is satisfied. Determination whether the reproposal condition is satisfied includes determining that the reproposal condition is satisfied, when a start condition for starting the lane change control is predicted to be satisfied.

According to still another embodiment, a non-transitory recording medium that stores a computer program for vehicle control is provided. The computer program includes instructions causing a processor mounted on a host vehicle to execute a process including determining whether a reproposal condition for reproposing lane change control for the host vehicle to change lanes is satisfied, when a proposal of the lane change control is not accepted or when execution of the lane change control is interrupted after acceptance of the lane change control; and reproposing execution of the lane change control to a driver of the host vehicle via a notification device provided for the host vehicle, when the reproposal condition is satisfied. Determination whether the reproposal condition is satisfied includes determining that the reproposal condition is satisfied, when a start condition for starting the lane change control is predicted to be satisfied.

According to yet another embodiment, a vehicle controller is provided. The vehicle controller includes a processor configured to: determine whether a start condition for starting lane change control for a host vehicle to change lanes is satisfied, after a proposal of the lane change control is not accepted or after execution of the lane change control is interrupted after acceptance of the lane change control, repropose execution of the lane change control to a driver of the host vehicle via a notification device provided for the host vehicle, when the start condition is satisfied, and start executing the lane change control when the driver performs operation of approval for the reproposal via an operating device provided for the host vehicle. The operation of approval for the reproposal is simpler than operation for the driver to give an instruction of the lane change control.

The vehicle controller according to the present disclosure has an advantageous effect of being able to repropose unfinished lane change control at appropriate timing.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit.

FIG. 3 is a functional block diagram of a processor of the electronic control unit.

FIG. 4 is an explanatory diagram illustrating an example in which a reproposal of lane change control is made.

FIG. 5 is an operation flowchart of a vehicle control process.

### DESCRIPTION OF EMBODIMENTS

A vehicle controller, a method for vehicle control executed by the vehicle controller, and a computer program for vehicle control will now be described with reference to the attached drawings. The vehicle controller reproposes once proposed and unfinished lane change control when a start condition for starting the lane change control is predicted to be satisfied. In the following, lane change control will be referred to as “LC control.” A proposal and a reproposal of lane change control will also be referred to as an “LC proposal” and an “LC reproposal,” respectively.

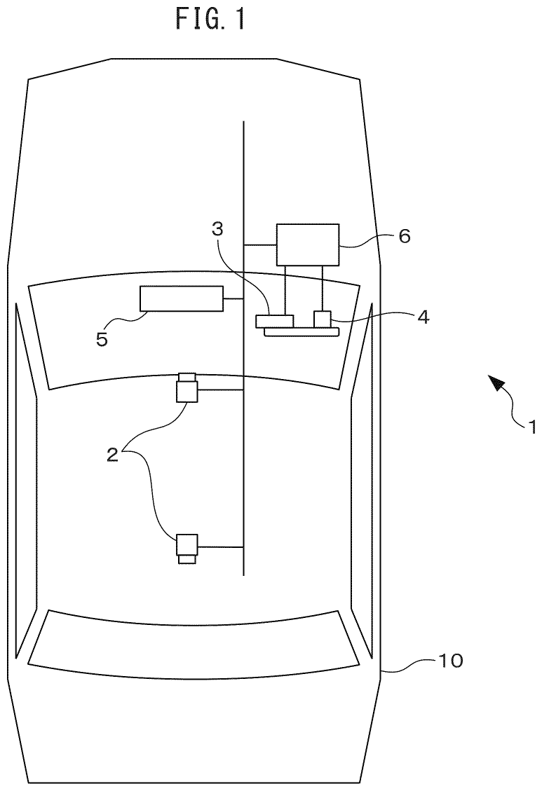

FIG. 1 schematically illustrates the configuration of a vehicle control system equipped with a vehicle controller. In the present embodiment, the vehicle control system 1, which is mounted on a vehicle 10 and controls the vehicle 10, includes at least one vehicle exterior sensor 2, at least one vehicle interior sensor 3, an operating device 4, a notification device 5, and an electronic control unit (ECU) 6, which is an example of the vehicle controller. The vehicle 10 is an example of the host vehicle. The vehicle control system 1 may further include at least one of a satellite positioning device (not illustrated), a navigation device (not illustrated), a wireless communication terminal (not illustrated), or a storage device (not illustrated) that stores a “high-precision map” used for autonomous driving control.

The vehicle exterior sensor 2 is a sensor for detecting surroundings in a predetermined detection range around the vehicle 10, e.g., a camera, or a range sensor, such as radar, or LiDAR. The vehicle 10 may include multiple vehicle exterior sensors having different detection ranges or differing in type. The vehicle exterior sensor 2 generates sensor signals representing the surroundings of the vehicle 10 at predetermined intervals, and outputs the generated sensor signals to the ECU 6.

The vehicle interior sensor 3 is a sensor for detecting an action of a driver of the vehicle 10, e.g., a driver monitoring camera installed in the vehicle interior so as to take pictures of the driver, or a touch sensor provided in the steering wheel. The vehicle 10 may include multiple vehicle interior sensors differing in type. The vehicle interior sensor 3 generates an interior sensor signal indicating the driver's action, and outputs the generated interior sensor signal to the ECU 6.

The operating device 4 is a device on which operation related to LC control is performed by the driver, e.g., one or more control buttons provided on a turn signal lever or the steering wheel, the turn signal lever itself, or a microphone. The operating device 4 outputs an operation signal or a voice signal indicating operation performed by the driver to the ECU 6.

The notification device 5 is provided in the interior of the vehicle 10, and gives predetermined notification to the driver by voice, light, or display of text or an image. To achieve this, the notification device 5 includes, for example, at least one of a speaker, a light source, or a display. When a notification signal indicating predetermined notification to the driver, such as an LC proposal or an LC reproposal, is received from the ECU 6, the notification device 5 gives the notification to the driver by outputting a voice from the speaker, lighting up or blinking the light source, or displaying an icon or a message on the display.

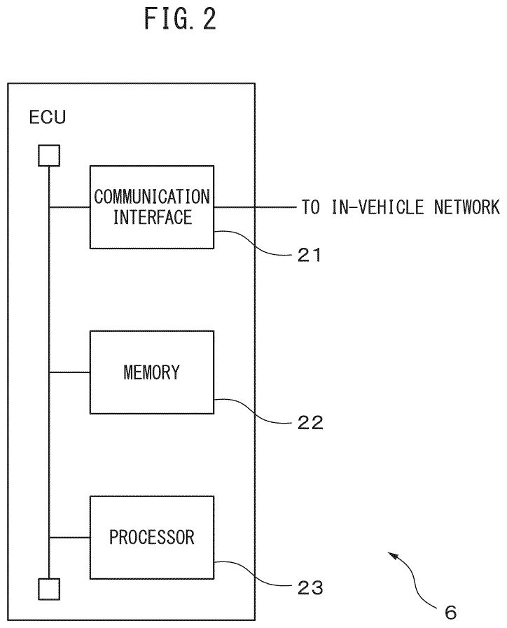

FIG. 2 illustrates the hardware configuration of the ECU 6. The ECU 6 includes a communication interface 21, a memory 22, and a processor 23. These may be configured as separate circuits or a single integrated circuit. The ECU 6 executes a process related to autonomous driving control or driving assistance including LC control.

The communication interface 21 includes an interface circuit for connecting the ECU 6 to the in-vehicle network. The communication interface 21 passes various signals received from the vehicle exterior sensor 2, the vehicle interior sensor 3, or the operating device 4 to the processor 23. Further, the communication interface 21 outputs a notification signal received from the processor 23 to the notification device 5.

The memory 22, which is an example of a storage unit, includes, for example, volatile and nonvolatile semiconductor memories. The memory 22 stores various types of data used in a vehicle control process executed by the processor 23. In addition, the memory 22 temporarily stores various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit.

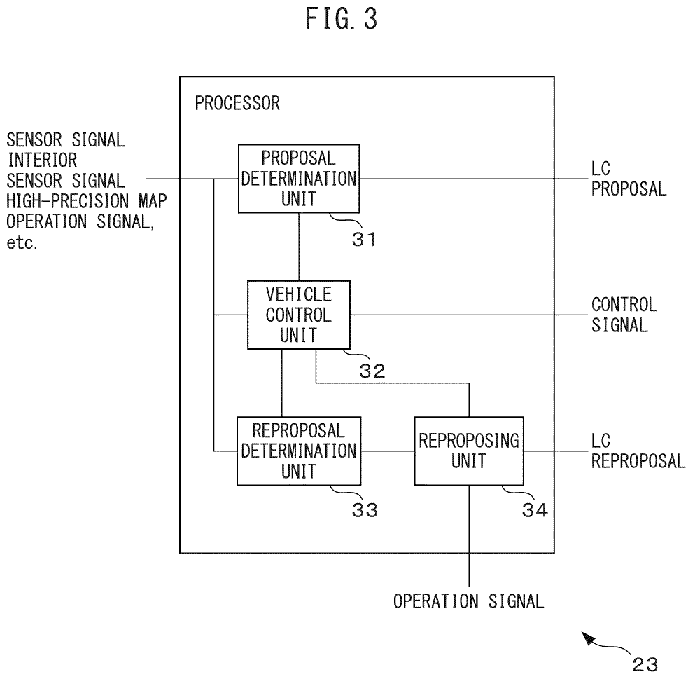

FIG. 3 is a functional block diagram of the processor 23. The processor 23 includes a proposal determination unit 31, a vehicle control unit 32, a reproposal determination unit 33, and a reproposing unit 34. These units included in the processor 23 are functional modules, for example, implemented by a computer program executed by the processor 23, or may be dedicated operating circuits provided in the processor 23.

The proposal determination unit 31 determines whether to make an LC proposal to the driver. For example, the proposal determination unit 31 determines to make an LC proposal, when the driver operates the operating device 4 to perform predetermined operation corresponding to a lane change to a left or right target lane. The predetermined operation may be, for example, pushing up or down the turn signal lever by a predetermined amount for a predetermined period, or any other operation.

The proposal determination unit 31 may determine whether to make an LC proposal, based on the circumstances of the vehicle 10. For example, the proposal determination unit 31 determines to make an LC proposal in which a lane leading toward a destination is a target lane, in the case where there is a fork in a section from the current position of the vehicle 10 to a predetermined distance away and where the lane being traveled by the vehicle 10 (hereafter the “host vehicle lane”) and the lane leading toward a destination diverge from the fork. The proposal determination unit 31 also determines to make an LC proposal in which an adjacent lane is a target lane, in the case where the host vehicle lane merges with the adjacent lane and disappears in a section from the current position of the vehicle 10 to a predetermined distance away.

In these cases, the proposal determination unit 31 determines that a lane including the position of the vehicle 10 determined by a satellite positioning device (not illustrated) is the host vehicle lane, by referring to a high-precision map. Instead of the position of the vehicle 10 determined by the satellite positioning device, the proposal determination unit 31 may use the position of the vehicle 10 detected based on a sensor signal obtained by the vehicle exterior sensor 2. In this case, the proposal determination unit 31 inputs a sensor signal into a classifier that has been trained to detect a predetermined feature, such as a lane line, a curbstone, or a traffic sign, thereby detecting features represented in the sensor signal. As such a classifier is used a classifier based on a machine learning technique, such as a convolutional neural network, AdaBoost, or a support vector machine. The proposal determination unit 31 projects the detected features onto a high-precision map, based on the mounted position and orientation of the vehicle exterior sensor 2, the positions of the detected features in the sensor signal, and an assumed position and travel direction of the vehicle 10, and calculates the degree of matching, such as the sum of squares of the distances between these features and corresponding features. The proposal determination unit 31 repeats the projection and calculation of the degree of matching while varying the assumed position and travel direction of the vehicle 10, and determines an assumed position of the vehicle 10 for the case where the degree of matching is the best as the actual position of the vehicle 10.

The proposal determination unit 31 determines whether there is a fork in the section to a predetermined distance away and whether the lane leading toward a destination diverges from the host vehicle lane at the fork, by referring to a planned travel route determined by a navigation device and the high-precision map. Similarly, the proposal determination unit 31 determines whether the host vehicle lane disappears, by referring to the high-precision map.

In addition, the proposal determination unit 31 may determine to make an LC proposal, in the case where the speed of a vehicle traveling ahead of the vehicle 10 is less than a target speed set for the vehicle 10 by more than a predetermined speed, and where there is a space for the vehicle 10 to enter in an adjacent lane. In this case, the proposal determination unit 31 inputs each of time-series sensor signals into a classifier that has been trained to detect a vicinity vehicle traveling in an area around the vehicle 10, thereby detecting vicinity vehicles from each sensor signal. Such a classifier may be a classifier similar to that used for detecting features. The proposal determination unit 31 applies a predetermined tracking technique, such as KLT tracking, to individual vicinity vehicles detected from each sensor signal to track the vicinity vehicles. In addition, the proposal determination unit 31 estimates the speeds of the tracked individual vicinity vehicles relative to the vehicle 10, based on time-varying changes in the distances between the vicinity vehicles and the vehicle 10. When the vehicle exterior sensor 2 is a range sensor, the proposal determination unit 31 determines the distance measured in the direction where a vicinity vehicle detected in a ranging signal, which is a sensor signal, is represented as the distance to the vicinity vehicle. When the vehicle exterior sensor 2 is a camera, the bottom of a region representing a vicinity vehicle in an image, which is a sensor signal, is assumed to correspond to the position where the vicinity vehicle is on the road surface. Thus the proposal determination unit 31 estimates the distance to the vicinity vehicle, based on the direction from the camera corresponding to the bottom of the region representing the vicinity vehicle and the height of the mounted position of the camera. The proposal determination unit 31 estimates the speed of each vicinity vehicle, based on the relative speed of the vicinity vehicle and the speed of the vehicle 10 measured by a speed sensor (not illustrated).

Of the detected vicinity vehicles, the proposal determination unit 31 identifies a vicinity vehicle in a predetermined angle range centered in the direction straight ahead of the vehicle 10 as a vehicle ahead. Alternatively, of the lane lines detected from a sensor signal, the proposal determination unit 31 determines two lane lines closest to the vehicle 10 in regions corresponding to the left and right of the vehicle 10 as the lane lines defining the host vehicle lane. Of the detected vicinity vehicles, the proposal determination unit 31 may then identify a vicinity vehicle in the region sandwiched between these lane lines defining the host vehicle lane as a vehicle ahead. In addition, of the detected vicinity vehicles, the proposal determination unit 31 identifies a vicinity vehicle in a region adjacent to the lane line defining the host vehicle lane as a vicinity vehicle traveling on an adjacent lane. The proposal determination unit 31 estimates the speed of the identified vehicle ahead, as described above. Further, the proposal determination unit 31 determines whether there is a space for the vehicle 10 to enter in the adjacent lane, based on the direction and distance to the vicinity vehicle traveling on the adjacent lane.

When making an LC proposal in response to the driver's operation, the proposal determination unit 31 notifies the vehicle control unit 32 that an LC proposal is made. When determining to make an LC proposal, based on the circumstances of the vehicle 10, the proposal determination unit 31 gives notification of an LC proposal via the notification device 5. For example, the proposal determination unit 31 causes a message or an icon indicating that an LC proposal is made to appear on the display included in the notification device 5. Alternatively, the proposal determination unit 31 causes the speaker included in the notification device 5 to output a voice signal indicating that an LC proposal is made. When the driver performs approval operation via the operating device 4 within a predetermined period after the notification of the LC proposal, the proposal determination unit 31 notifies the vehicle control unit 32 that an LC proposal is made. The approval operation may be the same as the operation of an LC proposal by the driver.

Upon an LC proposal, the vehicle control unit 32 determines whether to accept the LC proposal. When an LC proposal is accepted or an LC reproposal is approved, the vehicle control unit 32 executes LC control.

Upon an LC proposal, the vehicle control unit 32 determines whether a start condition of LC control is satisfied. Unless the start condition is satisfied within a certain period from the notification of an LC proposal, the LC proposal is not accepted. The start condition is that the circumstances of the vehicle 10 and the driver's action do not correspond to any of the following interruption conditions (i) to (vi). These interruption conditions are an example, and another interruption condition may be included, or some of these interruption conditions may be omitted.

(i) In the case where there is a traveling vicinity vehicle or a vicinity vehicle that is stopped or traveling slowly, for example, because of traffic congestion, within a predetermined range centered at the vehicle 10 on the target lane. In this case, the vehicle control unit 32 determines whether there is a vicinity vehicle within the predetermined range on the target lane, by executing processing similar to processing by the proposal determination unit 31 related to a vicinity vehicle. In addition, when an estimated speed of a vicinity vehicle ahead of the vehicle 10 on the target lane is not greater than a congestion determination threshold, the vehicle control unit 32 determines that the vicinity vehicle is stopped or traveling slowly.

(ii) In the case where a lane line or the host vehicle lane cannot be detected, where the accuracy of detection is not higher than a predetermined standard, or where the road being traveled by the vehicle 10 is in a situation in which LC control cannot be guaranteed, e.g., where the curvature or lane width of the road is outside a range in which safe execution of LC control is guaranteed. In this case, the vehicle control unit 32 executes the above-described processing related to detection of lane lines and the host vehicle lane on a sensor signal. When no lane line is detected from the sensor signal or detection of the host vehicle lane has failed, the vehicle control unit 32 determines that interruption condition (ii) is satisfied. When a confidence score of a lane line outputted by the classifier used for detecting lane lines is not higher than a predetermined threshold, the vehicle control unit 32 determines that interruption condition (ii) is satisfied, assuming that the accuracy of detection is not higher than a predetermined standard. In addition, the vehicle control unit 32 determines the curvature and lane width of the road by referring to the high-precision map. Alternatively, the vehicle control unit 32 may determine the curvature and lane width of the road, based on a lane line detected from a sensor signal. When the curvature is not less than a curvature threshold or when the lane width is less than a width threshold, the vehicle control unit 32 determines that interruption condition (ii) is satisfied.

(iii) In the case where the vehicle 10 is not in a state in which LC control can be executed, e.g., where the speed or the acceleration in the front-back or lateral direction of the vehicle 10 is outside a guarantee range in which safe execution of LC control is guaranteed. In this case, the vehicle control unit 32 determines whether a speed or an acceleration measured by a sensor configured to detect a predetermined motion of the vehicle 10, such as a speed sensor or an acceleration sensor, is within the guarantee range, thereby determining whether interruption condition (iii) is satisfied.

(iv) In the case where control having higher priority than LC control is being executed. Examples of control having higher priority than LC control are control related to a guarantee of safety, such as vehicle stability control (VSC), anti-lock brake system (ABS), or traction control system (TRC).

(v) In the case where the vehicle 10 is traveling in a lane change-prohibited section or is supposed to enter a lane change-prohibited section. In this case, the vehicle control unit 32 determines whether the vehicle 10 is traveling in a lane change-prohibited section or is within a predetermined distance of a lane change-prohibited section, by referring to the current position of the vehicle 10 determined by the satellite positioning device, the travel direction of the vehicle 10, and the high-precision map. Alternatively, the vehicle control unit 32 may determine that the vehicle 10 is traveling in a lane change-prohibited section, when an object for construction is detected from a sensor signal obtained by the vehicle exterior sensor 2. Alternatively, the vehicle control unit 32 may determine that interruption condition (v) is satisfied, when the current position of the vehicle 10 is within a lane-restricted section indicated by traffic information received via a wireless communication terminal, or when the distance from the current position of the vehicle 10 to the lane-restricted section is not greater than the predetermined distance.

(vi) In the case where the driver has not performed an action required of the driver for execution of LC control. The action may be, for example, holding the steering wheel or watching the surroundings. In this case, whether interruption condition (vi) is satisfied is determined based on interior sensor signals. For example, when the action required of the driver is holding the steering wheel, the vehicle control unit 32 determines that the driver is not holding the steering wheel, and that interruption condition (vi) is satisfied, unless a hold detection signal is received by the ECU 6 from the touch sensor, which is an example of the vehicle interior sensor 3. When the action required of the driver is watching the surroundings, the vehicle control unit 32 determines whether the driver is doing so, based on driver images obtained by the driver monitoring camera, which is another example of the vehicle interior sensor 3. In this case, the vehicle control unit 32 inputs a driver image into a classifier that has been trained to detect feature points of a face, thereby detecting each feature point. In addition, the vehicle control unit 32 fits the feature points into a three-dimensional face model representing the three-dimensional shape of a face. The vehicle control unit 32 determines the orientation of the face of the three-dimensional face model best fitted by the feature points as the orientation of the driver's face. When the orientation of the driver's face has been outside a predetermined angle range including the travel direction of the vehicle 10 for a period not less than a predetermined time threshold, the vehicle control unit 32 determines that the driver is not watching the surroundings, and that interruption condition (vi) is satisfied.

When an LC proposal is accepted or an LC reproposal is approved, the vehicle control unit 32 starts executing LC control. When starting LC control, the vehicle control unit 32 sets a planned trajectory for moving to the target lane, determines a steering angle so as to travel along the set planned trajectory, and controls the steering of the vehicle 10 so that the steering angle is the same as determined. To this end, the vehicle control unit 32 detects the position of the vehicle 10 as described in relation to detection of the host vehicle lane. The vehicle control unit 32 determines the steering angle of the vehicle 10 so that the detected position of the vehicle 10 approaches the planned trajectory. When the vehicle 10 has moved on the target lane, the vehicle control unit 32 finishes LC control.

When one of interruption conditions (i) to (vi) above is satisfied after the start of LC control and before the end of LC control, the vehicle control unit 32 interrupts execution of LC control. When a predetermined time has elapsed after approval of an LC reproposal without the start condition being actually satisfied, the vehicle control unit 32 also interrupts execution of LC control. In this case, the vehicle control unit 32 may control the steering of the vehicle 10 so that the vehicle 10 turns to return from the target lane to the host vehicle lane.

When an LC proposal is not accepted or when execution of LC control is interrupted, the vehicle control unit 32 notifies this fact to the reproposal determination unit 33.

The reproposal determination unit 33 determines whether a reproposal condition for making an LC reproposal is satisfied, when an LC proposal is not accepted or when execution of LC control is interrupted (in the following, these cases may be collectively referred to as the case where LC control is unfinished).

The reproposal condition is that the above-described start condition is predicted to be satisfied, i.e., all the interruption conditions are predicted to be no longer satisfied, after a predetermined action performed by the driver.

The predetermined action by the driver may be an action required of the driver related to interruption condition (vi), i.e., holding the steering wheel or watching the surroundings. Thus, when a hold detection signal is received by the ECU 6 from the touch sensor, as described in relation to interruption condition (vi), the reproposal determination unit 33 determines that the driver has performed the predetermined action. Alternatively, when the orientation of the driver's face detected based on driver images has been within the predetermined angle range over a predetermined time period, the reproposal determination unit 33 may determine that the driver has performed the predetermined action.

When the driver's predetermined action is detected, the reproposal determination unit 33 determines whether the start condition for starting LC control is predicted to be satisfied. More specifically, the reproposal determination unit 33 executes processing similar to processing for determining whether interruption conditions (i) to (v) are satisfied, and determines that the start condition is satisfied, when the interruption conditions are predicted to be no longer satisfied before the elapse of the predetermined time. When the start condition is satisfied, the reproposal determination unit 33 determines to make an LC reproposal.

For example, when LC control is unfinished because of interruption condition (i), the reproposal determination unit 33 predicts the relative position between the vicinity vehicle traveling on the target lane and the vehicle 10 after the elapse of the predetermined time, based on the relative speed and the relative position between the vicinity vehicle and the vehicle 10. When the predicted relative position is outside the predetermined range, the reproposal determination unit 33 determines that interruption condition (i) will be no longer satisfied. Further, the reproposal determination unit 33 predicts the speeds of individual vicinity vehicles traveling ahead of the vehicle 10 after the predetermined time, based on the changes in estimated speeds of the vicinity vehicles in a most recent predetermined period. When an average of the predicted speeds of the vicinity vehicles after the predetermined time is greater than a predetermined speed threshold, the reproposal determination unit 33 may predict that traffic congestion will be relieved after the predetermined time, and determine that interruption condition (i) will be no longer satisfied. Alternatively, the reproposal determination unit 33 may determine that interruption condition (i) will be no longer satisfied, when the vehicle 10 is predicted to reach the head position of traffic congestion, which is indicated by traffic information received via the wireless communication terminal mounted on the vehicle 10, within the predetermined time, based on the head position and the current position and speed of the vehicle 10.

When LC control is unfinished because of interruption condition (iii), the reproposal determination unit 33 executes a predetermined extrapolation process on the changes in the speed or acceleration of the vehicle 10 in a most recent predetermined period to predict the speed or acceleration after the elapse of the predetermined time. When the speed or acceleration after the elapse of the predetermined time is within the guarantee range, the reproposal determination unit 33 determines that interruption condition (iii) will be no longer satisfied. When LC control is unfinished because of interruption condition (v), the reproposal determination unit 33 predicts the time required for the vehicle 10 to pass through the lane change-prohibited section, based on the current position and speed of the vehicle 10 and the endpoint of the lane change-prohibited section. When the predicted time is less than the predetermined time, the reproposal determination unit 33 determines that interruption condition (v) will be no longer satisfied.

When the reproposal condition is satisfied within a predetermined reproposal period from timeout caused by failure to accept the LC proposal or from interruption of execution of LC control, the reproposal determination unit 33 notifies this fact to the reproposing unit 34. When the reproposal condition is not satisfied in the reproposal period, the reproposal determination unit 33 determines not to make an LC reproposal. Even before the elapse of the reproposal period, the reproposal determination unit 33 determines not to make an LC reproposal, when control of the vehicle 10 switches to manual driving control or when the vehicle 10 stops. The reproposal determination unit 33 may repeat an LC reproposal within the reproposal period until the number of LC reproposals reaches an upper limit.

When the reproposal condition is satisfied, the reproposing unit 34 notifies the driver of an LC reproposal via the notification device 5. To this end, the reproposing unit 34 causes a message or an icon indicating that an LC reproposal is made to appear on the display included in the notification device 5, similarly to notification of an LC proposal by the proposal determination unit 31. Alternatively, the reproposing unit 34 causes the speaker included in the notification device 5 to output a voice signal indicating that an LC reproposal is made. The reproposing unit 34 may change the expression of notification by the notification device 5 at an LC reproposal from the expression of notification of the first LC proposal.

When the driver performs operation of approval for the LC reproposal via the operating device 4 after the notification of the reproposal, the reproposing unit 34 notifies the vehicle control unit 32 that an LC reproposal is approved. When the driver has not performed approval operation even after a predetermined period from the LC reproposal, the processor 23 does not execute LC control again. The operation of approval for an LC reproposal may be simpler than the operation for the driver to propose LC control. For example, the operation of approval for an LC reproposal may be pushing down a predetermined button provided on the turn signal lever or the steering wheel, or voicing approval. When an LC reproposal is approved by voicing approval, the reproposing unit 34 applies a predetermined voice recognition technique, such as GMM-HMM, to a voice signal including the driver's voice obtained via the microphone. When a keyword corresponding to approval (e.g., “yes” or “do it”) is detected from the voice signal, the reproposing unit 34 determines that the operation of approval for an LC reproposal is performed. Simplifying the operation of approval for the reproposal in this way reduces the driver's annoyance.

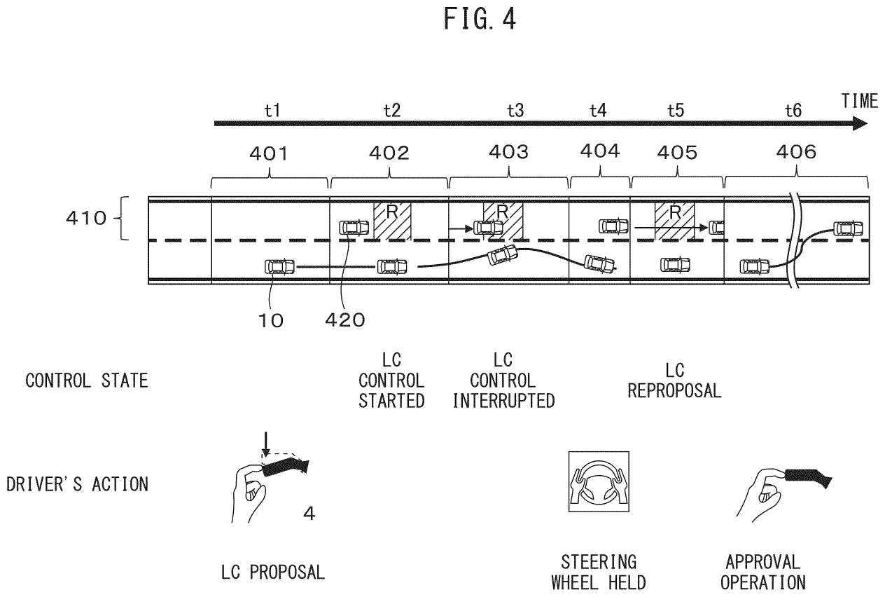

FIG. 4 is an explanatory diagram illustrating an example in which an LC reproposal is made. The horizontal axis in FIG. 4 represents time. Scenes 401 to 406 illustrate the surroundings of the vehicle 10 at times t1 to t6.

At time t1, the driver performs operation for an LC proposal via the operating device 4, as illustrated in scene 401. At time t2, a vicinity vehicle 420 traveling on a target lane 410 is not within a predetermined range R centered at the vehicle 10, as illustrated in scene 402, and none of the other interruption conditions is applicable; thus LC control is started. At time t3 after the vehicle 10 starts moving toward the target lane 410, the vicinity vehicle 420 enters the predetermined range R, as illustrated in scene 403, causing LC control to be interrupted.

Thereafter, at time t4, the driver holds the steering wheel, which is a predetermined action, as illustrated in scene 404. At time t5, the interruption conditions are predicted to be no longer satisfied in a predetermined time, i.e., the reproposal condition is satisfied, as illustrated in scene 405. Thus, the driver is notified of an LC reproposal via the notification device 5. At time t6, the driver performs operation of approval for the LC reproposal via the operating device 4, as illustrated in scene 406, causing LC control to be executed immediately.

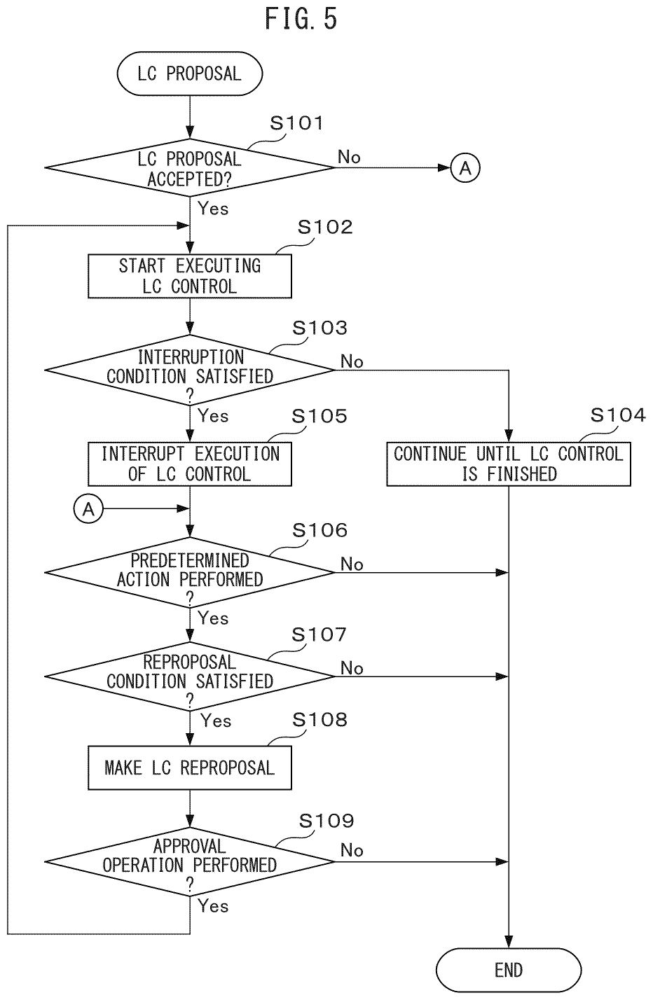

FIG. 5 is an operation flowchart of the vehicle control process executed by the processor 23 upon an LC proposal. The vehicle control unit 32 determines whether to accept the LC proposal (step S101). As described above, the LC proposal is accepted when the start condition is satisfied before the elapse of a predetermined time from the LC proposal. When the LC proposal is accepted (Yes in step S101), the vehicle control unit 32 starts executing LC control (step S102).

While executing LC control, the vehicle control unit 32 determines whether one of the interruption conditions is applicable (step S103). When none of the interruption conditions is applicable (No in step S103), the vehicle control unit 32 continues execution until LC control is finished (step S104).

When the LC proposal is not accepted in step S101 (No in step S101) or when one of the interruption conditions is applicable (Yes in step S103), the vehicle control unit 32 interrupts execution of LC control (step S105). Thereafter, the reproposal determination unit 33 determines whether the driver has performed a predetermined action (step S106).

When the driver's predetermined action is detected (Yes in step S106), the reproposal determination unit 33 determines whether the reproposal condition is predicted to be satisfied, i.e., all the interruption conditions are predicted to be no longer satisfied (step S107). When the reproposal condition is satisfied (Yes in step S107), the reproposing unit 34 gives notification of an LC reproposal via the notification device 5 (step S108). The reproposing unit 34 then determines whether the driver has performed approval operation (step S109). When approval operation is performed via the operating device 4 (Yes in step S109), the processor 23 repeats the processing of step S102 and the subsequent steps.

When the driver does not perform a predetermined action in a reproposal period (No in step S106) or when the reproposal condition is not satisfied in the reproposal period (No in step S107), the processor 23 terminates the vehicle control process without reproposing LC control. When approval operation is not performed even after the predetermined period from the LC reproposal (No in step S109), the processor 23 also terminates the vehicle control process without executing LC control again.

As has been described above, the vehicle controller reproposes unfinished lane change control when the start condition is predicted to be satisfied, and thus can repropose the control at appropriate timing when the control can be executed immediately. The vehicle controller can therefore improve the possibility of completing lane change control and reduce the driver's annoyance.

According to a modified example, the reproposal determination unit 33 may determine that the reproposal condition is satisfied, when the start condition is predicted to be satisfied, regardless of whether the driver performs a predetermined action. In this case, the processing of step S106 in the flowchart of FIG. 5 may be omitted.

According to another modified example, the reproposal determination unit 33 may determine whether the above-described start condition is satisfied, when an LC proposal is not accepted or when execution of LC control is interrupted after acceptance of an LC proposal. The reproposing unit 34 may then make an LC reproposal via the notification device 5 when the start condition is satisfied. In this case, the operation of approval for an LC reproposal is preferably simpler than the operation for the driver to give an instruction of LC control, as described in the embodiment. This reduces the driver's annoyance.

According to still another modified example, the upper limit of the number of LC reproposals or the reproposal period may be modified, depending on the reason for the first LC proposal. For example, when the reason for an LC proposal is that the host vehicle lane does not lead toward a destination or disappears, making a lane change is essential. Thus, when the reason for the first LC proposal is based on an essential lane change, the reproposal determination unit 33 sets the reproposal period relatively long or sets the upper limit of the number of times relatively high. In contrast, when the reason for an LC proposal is passing a vehicle ahead or the driver's instruction, making a lane change is inessential. Thus, when the reason for the first LC proposal is based on an inessential lane change, the reproposal determination unit 33 sets the reproposal period relatively short or sets the upper limit of the number of times relatively low. This causes repetition of a LC reproposal to be controlled appropriately, reducing the driver's annoyance.

The computer program for achieving the vehicle control process according to the above-described embodiment or modified examples may be provided in a form recorded on a computer-readable portable storage medium.

What is claimed is:

1. A vehicle controller comprising:
a processor configured to:
determine whether a reproposal condition for reproposing lane change control for a host vehicle to change lanes is satisfied, when a proposal of the lane change control is not accepted or when execution of the lane change control is interrupted after acceptance of the lane change control, and
repropose execution of the lane change control to a driver of the host vehicle via a notification device provided for the host vehicle, when the reproposal condition is satisfied, wherein
the processor determines that the reproposal condition is satisfied, when a start condition for starting the lane change control is predicted to be satisfied.

2. The vehicle controller according to claim 1, wherein the processor determines that the reproposal condition is satisfied, when the start condition is predicted to be satisfied after a predetermined action performed by the driver.

3. The vehicle controller according to claim 1, wherein the processor modifies the number of times or a period of notification of the reproposal, depending on a reason for proposing the lane change control of which execution is interrupted.

4. The vehicle controller according to claim 1, wherein the processor is further configured to start executing the lane change control when the driver performs operation of approval for the reproposal via an operating device provided for the host vehicle, wherein
the operation of approval for the reproposal is simpler than operation for the driver to give an instruction of the lane change control.

5. A method for vehicle control, comprising:
determining whether a reproposal condition for reproposing lane change control for a host vehicle to change lanes is satisfied, when a proposal of the lane change control is not accepted or when execution of the lane change control is interrupted after acceptance of the lane change control; and
reproposing execution of the lane change control to a driver of the host vehicle via a notification device provided for the host vehicle, when the reproposal condition is satisfied, wherein
determination whether the reproposal condition is satisfied comprises determining that the reproposal condition is satisfied, when a start condition for starting the lane change control is predicted to be satisfied.

6. A non-transitory recording medium that stores a computer program for vehicle control, the computer program causing a processor mounted on a host vehicle to execute a process comprising:
determining whether a reproposal condition for reproposing lane change control for the host vehicle to change lanes is satisfied, when a proposal of the lane change control is not accepted or when execution of the lane change control is interrupted after acceptance of the lane change control; and
reproposing execution of the lane change control to a driver of the host vehicle via a notification device provided for the host vehicle, when the reproposal condition is satisfied, wherein
determination whether the reproposal condition is satisfied comprises determining that the reproposal condition is satisfied, when a start condition for starting the lane change control is predicted to be satisfied.

7. A vehicle controller comprising:
a processor configured to:
determine whether a start condition for starting lane change control for a host vehicle to change lanes is satisfied, after a proposal of the lane change control is not accepted or after execution of the lane change control is interrupted after acceptance of the lane change control,
repropose execution of the lane change control to a driver of the host vehicle via a notification device provided for the host vehicle, when the start condition is satisfied, and
start executing the lane change control when the driver performs operation of approval for the reproposal via an operating device provided for the host vehicle, wherein
the operation of approval for the reproposal is simpler than operation for the driver to give an instruction of the lane change control.
